(19) United States
(12) Patent Application Publication
(10) Pub. No.: US 2015/0277496 A1
(43) Pub. Date: Oct. 1, 2015

(54) FOLDABLE ELECTRONIC DISPLAY

(71) Applicant: Flexenable Limited, Cambridge , Cambridgeshire (GB)

(72) Inventors: William Reeves, Cambridge (GB); Peter Hutchinson, Cambridge (GB)

(21) Appl. No.: 14/433,846

(22) PCT Filed: Sep. 24, 2013
(86) PCT No.: PCT/GB2013/052496

§ 371 Date: Apr. 6, 2015

(30) Foreign Application Priority Data
Oct. 8, 2012 (GB) 1218004.8
Oct. 22, 2012 (GB) 1218894.2

(51) Int. Cl. G06F 1/16; G06F 3/14; G09F 9/30

(52) U.S. Cl. CPC G06F 1/1641; G06F 1/1652; G09F 9/301; G06F 3/1438

(57) ABSTRACT

A foldable electronic display comprising first and second display panels. Each said display panel has opposed viewing and back sides and a curved edge between said viewing and back sides. Each display panel further comprises an array of pixels comprising display medium an electronics to control said array of pixels to display an image on said viewing side. The display comprises coupling means configured to retain a said edge of said first display panel adjacent to and substantially aligned to a said edge of said second display panel. The pixel array of at least said first display panel is curved to extend from said front, viewing side of the display panel at least to a region of said curved edge of the display panel. The coupling means is configured to allow rotation of a said display panel to roll the curved edge of a said first or second display panel over the adjacent edge of the other of the first and second display panels to open the display such that a boundary of the pixel array extension is not in an area visible to the user during said opening, said boundary in said region of said curved edge or back side of said first display panel.

### FIELD OF THE INVENTION

The present invention generally relates to a foldable electronic display, a method of unfolding an electronic display comprising a plurality of display panels, and more particularly to an electronic book and to an e-reader.

### BACKGROUND TO THE INVENTION

Display flexibility is currently exploited in consumer electronics devices only to a limited extent. One reason for this may be the challenge of integrating flexible displays into products, such that the benefits of the display flexibility may be fully exploited yet the product remains robust enough to be handled by consumers. More specifically, there remain challenges in providing a display device that has any one or more of, inter alia, the following features: (a) components that should not flex are held rigid, e.g., for robustness during use; (b) the display is flexible, e.g., similar to a sheet of paper; and/or (c) the display is thin and/or light, e.g. may be held and/or carried by the user with ease and/or convenience. Furthermore, it is desirable to improve the user experience of an electronic reading device such as an e-reader or electronic book, for example to bring the experience closer to that of reading a sheet of paper or a traditional paper book. It is further desirable to increase the usable area of a display device.

Merely for use in understanding the present invention, the following disclosure is referred to: http://wexler-global.com/products/79/347, which describes the “Wexler.Flex.One” (®) display.

The field of consumer electronics devices continues to provide a need for a technique to allow fuller exploitation of display flexibility, preferably providing any one or more of the above, or other, desirable and/or advantageous features.

### SUMMARY

According to a first aspect of the present invention, there is provided a foldable electronic display, comprising: first and second display panels, each said display panel having opposing viewing and back sides and a curved edge between said viewing and back sides and having an array of pixels comprising display medium, each said display panel further comprising electronics to control said array of pixels to display an image on said viewing side; and coupling means configured to retain a said edge of said first display panel adjacent to and substantially aligned to a said edge of said second display panel, wherein said pixel array of at least said first display panel is curved to extend from said front, viewing side of the display panel at least to a region of said curved edge of the display panel, and said coupling means is configured to allow rotation of a said display panel to roll the curved edge of a said first or second display panel over the adjacent edge of the other of the first and second display panels to open the display such that a boundary of the pixel array extension is not in an area visible to the user during said opening, said boundary in said region of said curved edge or back side of said first display panel.

Thus, in an embodiment, the edge of one display panel may be rolled over, e.g., against (not necessarily touching), the edge of another display panel, e.g., such that one edge rotates around or about the other (either or both of the panels may be rotatable). A pixel array of a display panel may extend around at least part of an edge facing a ‘spine’ of the display panel (the spine may be a central region of a display comprising only two equally sized panels, it is at least at an join, interface or coupling between adjacent two or more display panels). The pixel array region on the edge may thus cover the edge, optionally extending to the back side of the display panel, optionally covering a region of the back side of the display panel. Preferably at least some pixels on the panel edge are substantially hidden from a user viewing the viewing side when the display is in an open configuration (preferably fully open, i.e., when the viewing sides of the display panels lie in substantially the same plane such that the display is open flat) or during the entire rotation, e.g., from fully closed to fully open.

The curvature and extension of the pixel array in an embodiment may allow the user to be presented with a substantially (e.g., fully) uniform display area between an outer edge of each pixel array and the viewing side of the spine region between the panels. Substantially no physical boundary between the pixel array and an adjacent border area of the display panel at the spine side of the display panel may be visible, and/or in an area visible to, the user during rotation and/or display viewing; preferably this applies to one, some or all display panels in an embodiment. During opening and/or closing of the display, the user may thus observe merely a relative rotation of preferably rounded and touching/closely spaced display surfaces at the interface between the panels, similarly to the experience of opening/closing a book. Advantageously, the user may be unable to at least directly see any part of a mechanism for closing/opening the display, while he is facing in a direction to see the viewing sides if the display was flat open.

There may further be provided the foldable electronic display, wherein said adjacent curved edges are configured (e.g., coupled, and/or rounded) to allow a substantially constant distance between said edge of said first panel and said edge of said second display panel during said rotation, said distance preferably less than about (e.g., exactly) 5 mm, more preferably less than about, e.g., 0.3 mm, 0.5 mm, 1 mm or 2 mm, apart, or optionally zero mm apart. Thus, the adjacent panels may be in contact, or not in contact, e.g., almost touching. The display may then give the impression of a substantially continuous but foldable display, for example when a single display image is displayed across both panels. When in an open configuration, there may be a small air gap between the panels at least in the plane(s) of the viewing sides. The adjacent panel edges may be substantially (e.g. exactly) parallel. In a preferred embodiment, the adjacent panel edges are parallel and the gap between them is zero and/or constant width.

There may further be provided the foldable electronic display, wherein there is no intermediate element, e.g., part of the coupling means, between the said edge of said first display panel and the said edge of said second display panel when the display is in a configuration wherein a user can view the viewing sides of the display panels, e.g., open flat.

There may further be provided the foldable electronic display, wherein at least one said display panel comprises a said pixel array having at least one margin portion comprising pixels that are not configured to be switchable by said electronics of said at least one display panel, and a said margin portion comprises said edge of the pixel array. Thus, pixels on the viewing side, and preferably not the pixels on the edge, of a panel may be controllable, i.e., switchable by the electronics. Preferably, the margin portion is directly adjacent the portion of the pixel array controllable by the electronics.

Thus, in an embodiment, at least one pixel array of a panel may have both a driven portion and a non-driven portion. The electronics of a display panel having both such portions may control the driven portion to display an image, preferably only the driven portion being visible to a user when the display is in an open configuration.

There may further be provided the foldable electronic display, wherein at least one fixed image is provided (e.g., permanently displayed, or permanently printed on/over) on a said margin portion and the display comprises electronics configured to control pixels of a said pixel array to display an option selected by a user, said option represented by a said fixed image.

There may further be provided the foldable electronic display, wherein at least one of the display panels comprises: a substantially rigid support for said electronics of said at least one display panel, said support in and/or on a portion of the at least one display panel, said portion substantially adjacent a said curved edge of said at least one display panel, wherein an other portion of the at least one display panel is flexible. The support may be a substrate, protective cover and/or housing for the electronics; the or each panel may have such a support. Preferably, each support is confined to be in and/or on a part or sub-region of the respective panel, e.g., confined to a strip along the length of and adjacent the spine of the display. The flexibility of a display panel may mean that the display is bendable, similarly to flexibility of a paper sheet, thus a layered structure of a display panel may flex across its entire cross-section. The flexibility in an embodiment may not by merely to allow depression of a viewing surface in response to pressure e.g. from a finger for touch control of the display.

There may further be provided the foldable electronic display, wherein said coupling means comprises gears, said first display panel coupled to a first said gear and said second display panel coupled to a second said gear, the first and second gears configured to mesh to allow said rotation. Each gear may have teeth, or cogs, which mesh with those of the other gear to allow the rotation while maintaining the alignment of the panel edges. Preferably, the first and second gears are offset from the display panels. Additionally or alternatively, gears are used to provide some resistance to rotation of the adjacent panels, for example when the foldable display embodiment is already opened to a desired extent. Thus, in an embodiment, rotational movement of the adjacent panel edge(s) about the spine is at least dampened when no force is being applied to at least partially open/close the display, e.g. by the user and/or by an optionally powered (e.g., electrically) mechanism designed to at least partially close and/or open the display. Preferably, such gears substantially stop the adjacent panels ‘flopping about’ when a user is viewing the display.

There may further be provided the foldable electronic display, configured to display an image extending from the viewing side of the first panel to the viewing side of the second display panel. Thus, a single image may be displayed substantially continuously across two or more panels, e.g., using both panels to display full A4 or A3 page so that the display acts as a foldable A3 or A4 paper sheet.

There may further be provided the foldable electronic display, wherein at least one said display panel comprises a single edge drive display.

Preferably the foldable electronic display is configured to allow a said rotation to open the display such that the viewing sides of the display panels can be viewed by a user and configured to allow a said rotation to close the display. Such a display may comprise a protective spine cover, extending over at least a portion of said rear side of said first display panel and at least a portion of said rear side of said second display panel and having slack (e.g., a length, e.g., of loose and/or looped material, in a direction from the first to second panels across the axis of relative rotation of the displays) to allow rotation of at least one said display panel relative to the other said display panel to close the display. In an embodiment, electrical connections required between the adjacent panels are provided under, and thus may be hidden by, the protective spine cover (preferably loose material).

There may further be provided the display comprising a protective display panel cover having: a flexible portion over a said other, flexible portion of the first display panel and a flexible portion over a said other, flexible portion of the second display panel; and a substantially rigid portion over the or each said support (e.g., the rigid portion fully rigid, or at least less flexible than the flexible portion of the protective cover). The protective display panel cover may have a thickness that is tapered over at least one said display panel, said tapering from a said flexible portion to a said substantially rigid portion.

There may further be provided an electronic book or an e-reader comprising a foldable electronic display according to any preceding claim. The electronic book may use two or more display panels as described above, such that each panel corresponds to a physical page of a book. The e-reader may be configured to display a single image across the two or more display panels. Alternatively, the foldable electronic display may form the display of a laptop or desktop computer, a PDA (personal digital assistant), a mobile phone, in particular a Smartphone, or other such device. If used with a touch sensor, at least of the panels of an embodiment may be used for “user data entry”, e.g., my means of a touch-sensitive keyboard and/or trackpad.

There may further be provided the foldable electronic display, wherein said display medium comprises an electrophoretic, electrowetting or electrofluidic display medium, e.g., electronic paper (“e-paper”), or comprises an emissive display medium (e.g., for light emitting diodes) or a transmissive medium, e.g., liquid crystals.

In a preferred embodiment, the or each display panel is preferably flexible and/or comprises an electrophoretic display screen, an electro-wetting display screen or electrofluidic display screen. Such flexibility is advantageous where a pixel array is to be bent or curved, e.g., around an edge of a panel facing the spine, to hide non-driven pixels from a user viewing an active area of the array. These displays are reflective display mediums. Electrofluidic displays enable improved brightness/contrast as well as high resolution screens and near video display update rates. Where an electrofluidic display is employed, for example of the type available from Gamma Dynamics, Inc. Ohio USA, the colour filter array may be omitted. The use of an electrofluidic display facilitates improved brightness/contrast as well as near video display update rates and high resolution, in embodiments of order 225 pixels per inch. Electrophoretic displays are an example of reflective display mediums, which allow the display device to be used in bright light conditions, such as outdoors. A colour display may be provided by providing a colour filter array over the electrophoretic display medium.

In a preferred embodiment, a flexible display screen of the types mentioned above comprises: a flexible plastic substrate; an array of organic thin film transistors (TFTs) on said substrate; a layer comprising conductive tracks for addressing said array; a layer of display medium (preferably electronic paper display medium) over said array of organic TFTs; a front window over said electronic paper display medium; preferably a layer of touch sensing tracks between said front window and said display medium and/or further comprising a stripe of magnetic material mounted on a said substrate along an edge of said display, in particular within a thickness of the device. Additionally or alternatively, an embodiment may comprise a flexible frontlight and/or inductive sensors.

In a preferred embodiment, the organic TFTs are mounted on a display backplane on said flexible plastic substrate; and the flexible display screen further comprises: display interface electronics for said display, coupled to said display backplane; wherein said flexible plastic substrate extends beyond a border of said display; and wherein at least a portion of said display interface electronics is fabricated on said flexible plastic substrate.

According to a second aspect of the present invention, there is provided a method of unfolding an electronic display comprising a plurality of display panels, at least one said display panel having an array of pixels on a viewing side of the panel and extending at least to cover a region of a curved edge of the panel, the method comprising: rolling the edge of said at least one display panel over an edge of an adjacent said display panel to open the display to a configuration wherein a user can view the viewing sides of the display panels, wherein pixels covering said region of said curved edge are substantially not visible to said user viewing said viewing side when the display is in said configuration.

Preferably, the pixels on the region of the curved edge of the at least one display panel are not configured to be switchable. The edges that are rolled over, e.g., against, each other may be in contact during said rolling, or may be separated by a distance as defined in relation to the first aspect above. Where there is a separation, any intermediate element, e.g., part of a means for coupling the panels, is substantially not visible to the user in the separation between the panels. Preferably there is at least no intermediate element between the panel edges in the plane(s) of the viewing sides.

According to a further aspect of the invention, there is provided a foldable electronic display, comprising: first and second display panels, each said display panel having opposing viewing and back sides and an edge between said viewing and back sides and having a screen comprising an array of pixels comprising display medium, each said display panel further comprising electronics to control said array of pixels to display an image on said viewing side, wherein each said display panel comprises a flexible support on the back side of the display panel to support the screen; and first and second structural components, each said structural component comprising a protective cover and attached to a said display panel such that the protective cover covers said electronics of the display panel and a width of the protective cover extends from or over a said substantially aligned edge of the display panel to said flexible support of the display panel, wherein the protective cover has a surface region facing away from the electronics and arranged to be adjacent and in substantially the same plane as a surface region of the flexible support, said surface region of the flexible support on the back side of the display panel; and coupling means to couple said first and second structural components such that a said edge of said first display panel is retained adjacent to and substantially aligned to a said edge of said second display panel while allowing at least one said display panel to rotate to open the folding electronic display for user viewing of the viewing sides.

The back side of at least one of the display panels is preferably an external side of the display. Preferably the protective cover surface region and flexible support surface region are substantially flush at least a join between the protective cover and flexible support. Thus, an embodiment may comprise, preferably as external elements of the display, both a mid-frame to support the screen and a substantially rigid protective cover over the electronics but may remain thin, for example due to the mid-frame and cover not be in separate layers but being provided alongside each other in the substantially the same plane.

One or both display panels may be fully flexible (excluding the region having the electronics preferably including a circuit board), e.g., the display panel as a whole (excluding the electronics) is bendable, preferably similarly to flexibility of a paper sheet, thus a layered structure of the display panel and/or screen may flex across its entire cross-section. The flexibility in an embodiment may not be merely to allow depression of a viewing surface in response to pressure e.g. from a finger for touch control of the display. Preferably, the or each display panel comprises a single edge display (SED) as described above; however alternative embodiments may have electronics along both sides of the screen.

The flexible support, otherwise referred to as a mid-frame, is preferably sufficiently flexible to allow flexibility/bending of the display as a whole as described above. The support may be formed of plastic and may be located between the display panel and an optional back casing or housing of the display. Advantageously, the flexible support is arranged to and/or sufficiently rigid to at least reduce or prevent kinks forming in the screen. In general the mid-frame backs all of the display substrate to stop sharp radii of curvature. These sharp radii are usually caused by “kinks” or sharp objects being dropped onto the surface, or a sharp object (or even a bit of dirt) under the display. Thus, preferably the support provides some support to substantially (e.g., all) of the screen. However, in an embodiment the support may have a frame shape, e.g., substantially following the periphery of the display panel and/or having a hole in the middle such that the screen is not directly supported across its entire extent.

The or each structural component may be fully or partially rigid, and/or preferably has rounded/curved edge facing the axis of rotation of panel(s) for opening the display.

At least one of the attachments of a structural component to the display panel may be achieved in an embodiment by, e.g., screw(s) through holes in an edge of the structural component into the edge of the display panel; preferably attaching to ‘receive’ the electronics (preferably comprising a PCB). The or each screw may be received by a corresponding threaded hole of a component mounted with the electronics.

The display panel may be provided with one or more substantially rigid (preferably elongate) components, e.g. bars and/or strips, preferably along an outside edge(s) of the electronics; such components may advantageously attached, e.g., part of, the flexible support, and/or attached to the electronics, e.g., PCB. Preferably the component(s) provides some protection to the electronics and/or some support to reduce flexing of the electronics. Regardless, the component(s) may be shaped to fit against a protective cover when the structural component is attached to the display panel concerned, preferably such that discrete electronic components are fully enclosed, e.g., by the protective cover, substantially rigid components and/or a said PCB or additional cover behind the electronics.

The coupling means may comprise a hinge, e.g., having a cylindrical bar extending through aligned holes in the structural components.

There may further be provided such a foldable display, combined with any one of more of the above aspects and optional features of embodiments.

Preferred embodiments are defined in the appended dependent claims.

Any one or more of the above aspects and/or any one or more of the above optional features of the preferred embodiments may be combined, in any permutation.

### BRIEF DESCRIPTION OF THE DRAWINGS

For a better understanding of the invention and to show how the same may be carried into effect, reference will now be made, by way of example, to the accompanying drawings, in which:

FIG. 1 shows an embodiment in a closed configuration;

FIG. 2 shows views of an embodiment in an open configuration: (a) front view; and (b) side view of spine region of device;

FIG. 3 shows a flexible spine of an embodiment;

FIG. 4a shows a cross-sectional structure of the display of an embodiment, and FIG. 4b shows an alternative such cross-sectional structure;

FIG. 5 shows a view of the back of an embodiment;

FIG. 6 shows a side view of an embodiment in (a) closed and (b) open configuration;

FIG. 7 shows user interface enhancements in a painted border example embodiment;

FIG. 8 shows a block diagram of a system comprising the embodiment;

FIG. 9 shows a schematic illustration of an electronic reading device according to a first embodiment of the invention;

FIG. 10 shows, schematically, connections to display interface electronics for the device at FIG. 1;

FIG. 11 shows, schematically, a folding version of the device at FIG. 1;

FIG. 12 shows a detailed vertical cross-section view through a second embodiment of an electronic reading device according to the invention;

FIG. 13 shows a front window for the device of FIG. 4, incorporating a touch-sensor;

FIG. 14 shows a colour filter array for the device at FIG. 4;

FIG. 15 shows a display media layer for the device at FIG. 4;

FIG. 16 shows a substrate/backplane layer for the device at FIG. 4 mounting display interface electronics;

FIG. 17 shows a front side of a flexible PCB for the device at FIG. 4;

FIG. 18 shows a rear face of the flexible PCB at FIG. 9;

FIG. 19 shows a view of the rear of the device at FIG. 4 when the back cover is not present;

FIG. 20 shows a rear view of the device at FIG. 4;

FIG. 21 shows an edge profile of the device at FIG. 4;

FIG. 22 shows a front view (upper drawing) and side view (lower drawing) of a display wherein the display is closed;

FIG. 23 shows side view (upper drawing) of part of the display of FIG. 22, and the user's view of the further concept including viewing surface (lower drawing), when the display is fully open;

FIG. 24 shows a view of the display of FIG. 22 when partially open;

FIG. 25 shows a user's view of the display of FIG. 22 including viewing surface, when the display is fully open, wherein tabs across the top read (from left to right): home; last read; library; search; settings; tasks; notes; calendar; web; apps;

FIG. 26 shows a view of attachment of a display panel into a mid-frame to assemble the display of FIG. 22; and

FIG. 27 shows an alternative view of the attachment of FIG. 26, this view showing an underside of the display panel and thus exposed electronics elements, e.g., electrical connectors.

The above figures generally relate to a single embodiment; however, an embodiment may be represented by any one or more of the figures.

### DETAILED DESCRIPTION OF PREFERRED EMBODIMENTS

In a preferred embodiment, the illusion of a folding display may be achieved by “conforming” display panels rather than by folding a display screen. The display panels preferably have curved edges adjacent the spine, e.g., are permanently bent around a tight radius, e.g., less than about 3 cm, 2 cm, 1 cm, 0.5 cm or 0.3 mm, to achieve such an illusion.

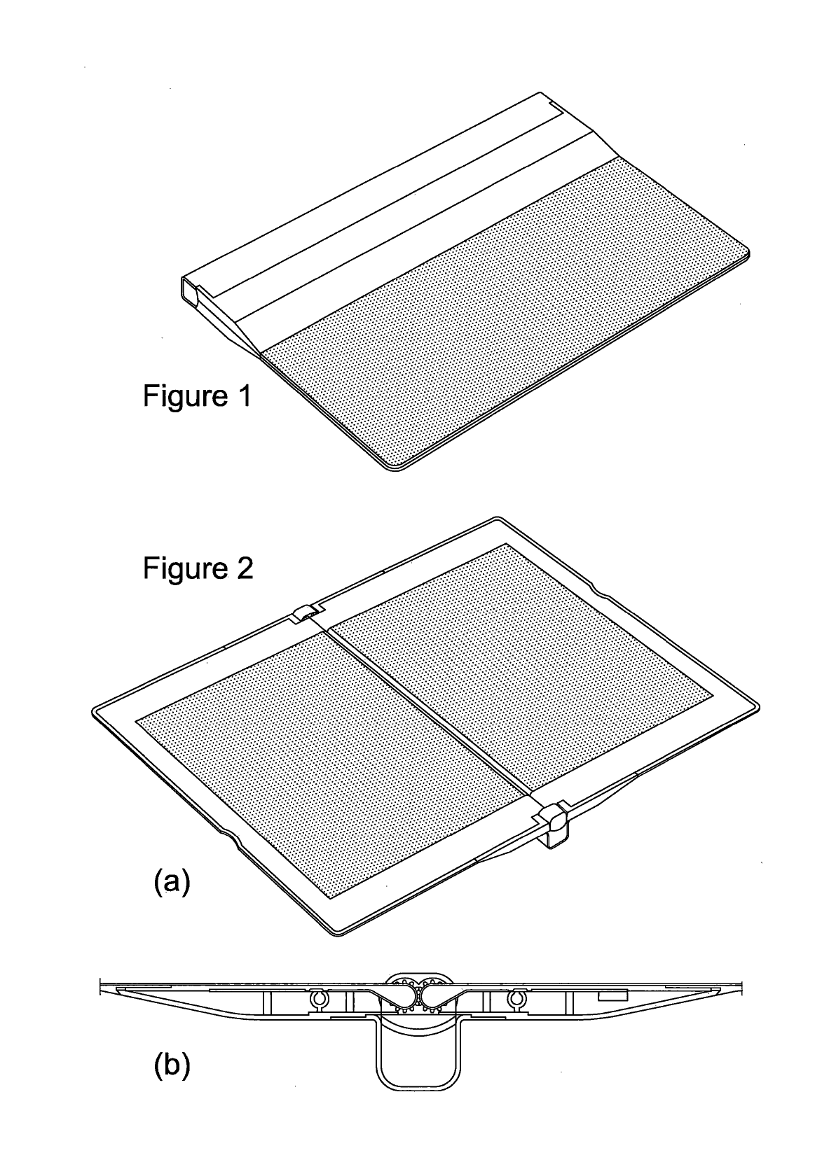

FIGS. 1 and 2 show screen shots of an example implementation. As shown in FIG. 2, two single-sided drive (SED) display modules or panels can be opened into a “book-like” format. Preferably all visible areas of the two panels are switchable, i.e., controllable by electronics to display image(s), preferably according to user input. This may be achieved by bending the displays around a tight radius such that any non-switching areas between the displays are hidden from view. The smaller the radius of curvature the more seamless the apparent join between the displays.

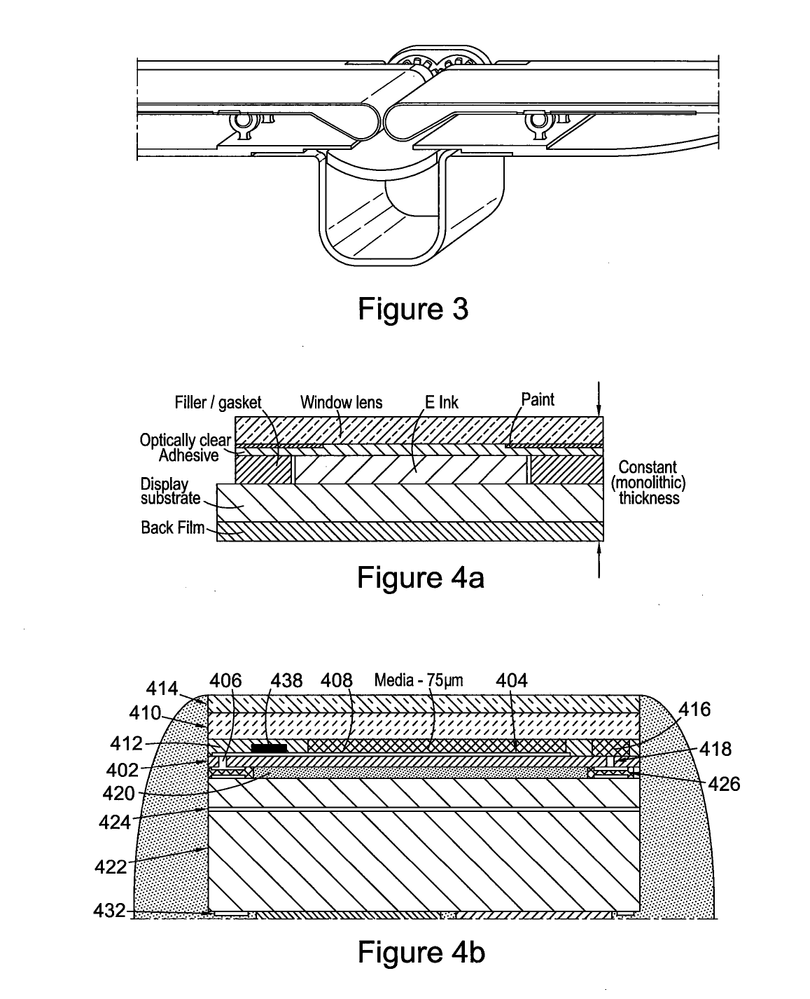

As shown in FIG. 3, the embodiment may have gears added so that the display panels always move relative to a substantially fixed spine and essentially “roll around” each other. In an embodiment, the display panels may touch; in other embodiments they may be separated by a very short distance such that they almost touch, thus advantageously enhancing the illusion of a folding display. Gears may be used in an embodiment to provide some preferably small resistance to motion, e.g., to improve the feeling of quality.

A flexible spine in the embodiment allows the display to open, and optionally hides any interconnections between the adjacent panels either side of the spine. Such a spine may allow for different radii of curvature, acting in the same/similar way as the spine of a paper book. In FIG. 3, the curved element looping underneath the display panels (see lowest element in FIG. 3) represents a spine of the embodiment.

Preferably, magnets are provided in the embodiment to ensure that the display comprising the panels is held together when in the closed state.

The embodiment may be very thin and/or light, e.g., 270 g, or with certain PCB and battery estimates at least less than 400 g; this is very light for a device having relatively large screen area.

FIG. 4b shows an example vertical cross-sectional view through a display screen of a display panel. In this example, electronic components of the device are located along an edge of the device on a flexible PCB, however in another embodiment they may be located on the rear side of the panel and preferably near/adjacent the spine. A display medium 408 is attached to substrate 402, for example by adhesive.

In more detail, the structure comprises a substrate 402, typically a plastic such as PET (polyethyleneterephthalate) or pen(polyethelenemaphthalene) on which is fabricated a thin layer of organic active matrix pixel circuitry. The circuitry may comprise an array of organic (or inorganic) thin film transistors for example as previously described in our WO01/47045, WO2004/070466, WO01/47043, WO2006/059162, WO2006/056808, WO2006/061658, WO2006/106365 and WO2007/029028. Broadly speaking in embodiments the backplane is fabricated using solution based techniques patterned by, for example, direct-right printing, laser ablation or photolithography to fabricate the thin film transistors. In embodiments the active devices have a thickness of order 5-10 μm. In embodiments this layer has a thickness of order 50 μm and has integrated encapsulation. This substrate/backplane layer bears row and column data lines and address conductive tracks 404, connected to the rear of substrate 402 by vias 406. We here refer to front as being towards the display surface of the screen and rear as being towards the rear of the screen.

A display medium 408 is attached to substrate 402, for example by adhesive. In preferred embodiments the display medium is a reflective display medium (which facilitates daylight reading), for example an electrophoretic display medium or an electrofluidic display medium. Where an electrophoretic display medium is employed a colour display may be provided by providing a colour filter array 410 over the display medium; optionally this may also perform an encapsulation function. Additionally or alternatively a moisture barrier may be provided over the display, for example comprising polyethylene and/or Aclar™ (a fluropolymer, polychlorotrifluoroethylene-PCTFE). In some embodiments the thickness of the display medium is of order 75 μm and that of the encapsulation/colour filter array of order 120 μm.

Where an electrofluidic display is employed, for example of the type available from Gamma Dynamics, Inc. Ohio USA, the colour filter array may be omitted. The use of an electrofluidic display facilitates improved brightness/contrast as well as near video display update rates and high resolution, in embodiments of order 225 pixels per inch.

In embodiments whichever display medium is employed, an edge seal is provided to seal the edge of display medium to the edge of the display screen.

As described above, the display medium is a reflective display medium (which facilitates daylight reading), in particular an electronic paper display medium, for example an electrophoretic display medium or an electrofluidic display medium. Alternatively, the/each display panel may have an emissive, e.g., LED, or transmissive, e.g., LCD, screen.

A front window 414 may be provided, for example comprising a thin layer of PMMA (polymethylmethacrylate). Where the screen is to be touch sensitive, this layer may also include conductive row and column lines for the touch circuitry. The touch sensing circuitry may be operable by finger and/or a stylus. A connection to the touch sensing layer may be made by a Z-axis conductive pad 416 which connects to the touch electrodes in window 414 through CFA/encapsulation layer 410 (for example by vias, not shown) and vias 418 through substrate 402 bring the touch array connections to contact pads on the rear of substrate 402.

An adhesive layer 420 may connect the substrate 402 to a flexible PCB 422 (which may incorporate circuitry 424 for an inductive stylus sensor. Connections between the contact pads on the rear of substrate 402 and the flexible PCB employ an anisotropic conductive film (ACF) 426. The illustrated structure facilitates the omission of a separate moisture barrier under substrate 402, although such a barrier may be incorporated if desired.

A flexible PCB may carry electronic components, for example surface mounted components, and a thin film flexible polymer battery. Flexible PCB also may bear a conductive loop 432 around the border of the device for inductive charging of battery 430. A storage device may also be carried on the flexible PCB. A thin back cover 434 may be used to provide a protective layer as described above, which may protect against impact or be waterproof. Optionally a magnetic strip may be mounted along an edge of the substrate.

However, the structure of FIG. 4b may have circuitry was built as a “mid-frame”. In contrast, the alternative, stacked structure of FIG. 4a is more compatible with the “fold around concept” of an embodiment wherein a pixel array of a display panel(s) is curved/bent away from the viewing surface at an edge by the spine, to hide non-driven pixels. FIG. 4a shows an example of display screen structure wherein all parts are built up to provide a uniform thickness, advantageously to thus ensure that all forces are transmitted through the display.

However, a number of technologies are advantageous for implementing additionally or alternatively in the embodiment, e.g.,:
single edge drive (SED) display unit, e.g., comprised in each display panel, preferably to allow control electronics to be confined, e.g., to near the spine of the foldable display;
materials allowing thin layers of the display (e.g., E-ink, substrate, etc.), advantageously reducing total screen weight and/or thickness; and/or
monolithic display module, e.g., wherein all layers of the display screen are integrated within the display screen structure, advantageously reducing total screen thickness.

A construction having one or more of the above features may allow the display to be a substantially constant thickness and/or to design an ultra-thin product with no bezel. Cross-sectional structures, which may be found in an embodiment such as the construction having one/more of the above features, are shown in FIG. 4a or 4b. Using such a structure, a display panel is constructed so that it is substantially one thickness (this preferably relating to the display screen as such, i.e., substantially excluding the control electronics). The construction method involves all of the materials initially being oversized. Final profiling is then performed with a laser (or otherwise) to ensure that all of the edges are flush (with the exception of the edge where the electrical connections are made).

A uniform or monolithic thickness is preferably achieved using, e.g., the FIG. 4a structure. This may ensure that all loads are transferred preferably evenly through the display screen with less chance of damage.

An optional protective cover for the display panels, e.g., housing, may in an embodiment not need to be rigid or very strong. If the display panel(s) can flex, the housing may only need to stop or reduce “kinks” and small bends and can thus be very thin.

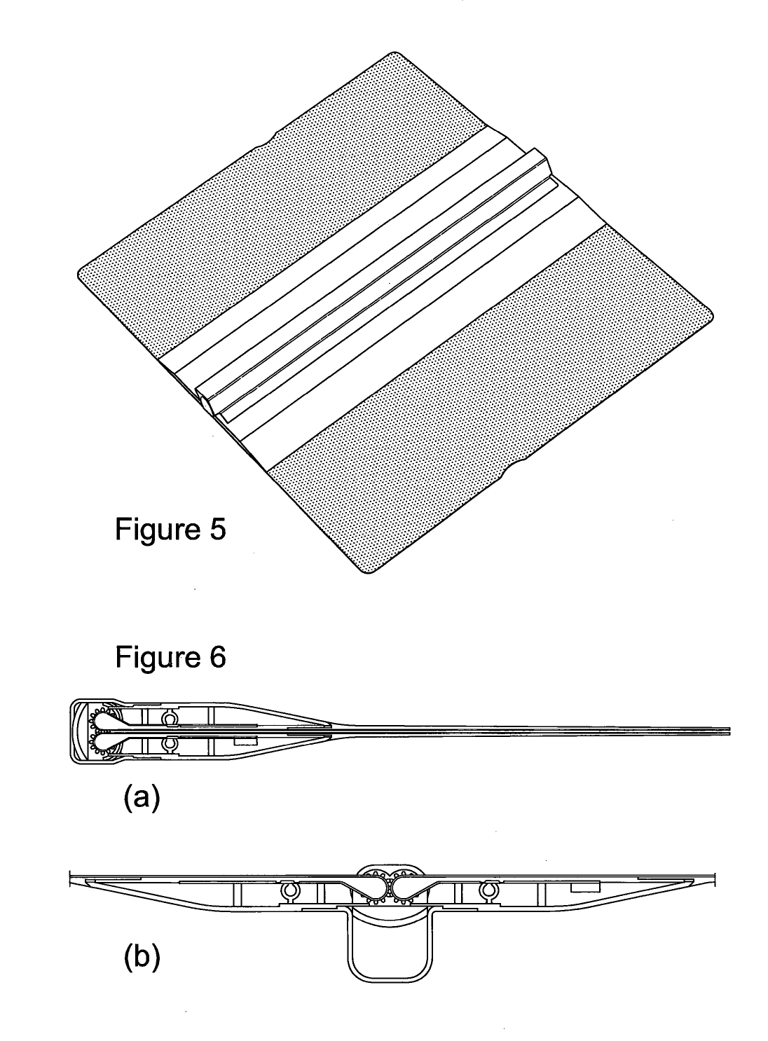

By carefully selecting the housing materials, it is possible to choose which areas flex and which do not. FIG. 5 shows the back of such a housing. Areas near the display spine (see each of the two areas between the central spine region and an outer, side regions of the cover in FIG. 5) are preferably less flexible than the spine or outer regions or are substantially rigid, these more rigid areas being over the corresponding maximum thickness areas of the display panels (the display panels correspondingly rigid in this area, e.g., to protect and/or support the control electronics - the non-flexible components such as the battery and PCB are preferably located in these areas). By tapering the cover (case or housing) towards the display edges and/or choosing a more flexible material (two outer, side regions (largest) of the cover in FIG. 5), the display product (display comprising cover) may have higher flexibility only where preferable. A cross-sectional view of such a product is shown in FIG. 6(a).

Even though the display contains two display panels, and optionally the protective cover, it may remain very thin even at the thickest section, e.g., 18mm when closed and half of that when open (FIG. 6(b)).

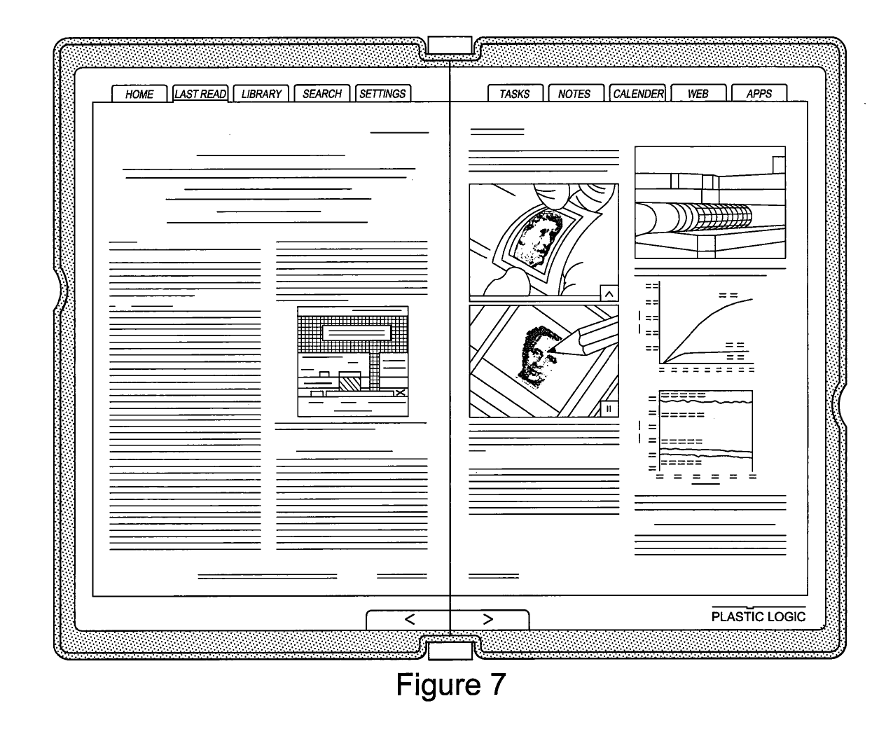

In the embodiment, some user interface features may be provided that make use of a non-driven border in the form of tabs, buttons and tools. For example, in FIG. 7 the tabs are provided in non-driven regions such that they appear to be selectable by driving a thin line on the display; specifically, in FIG. 7, “Last Read” has been selected. This may help to maximise the reading area whilst extending the usable area of the screen. Advantageously, an embodiment provides both a high viewable area (cm²) and a low weight per unit of viewable area (cm²). For example, the overall viewable size of the display in FIG. 7 is about 316 mm×217 mm, 15.1″ diagonal with approximately 1860×1280 pixels. Preferably, the width and/or length of the viewable region of the display panels is bigger than for A4 paper. Specific data of an embodiment are below:

Size: 276×181×18

Resolution: 1860×1280

Diagonal: 15.1″

Display size: 316.4×217.6

Area (cmsq): 688.4864

Weight (estimate)(g): 365

g/cmsq: 53.01485

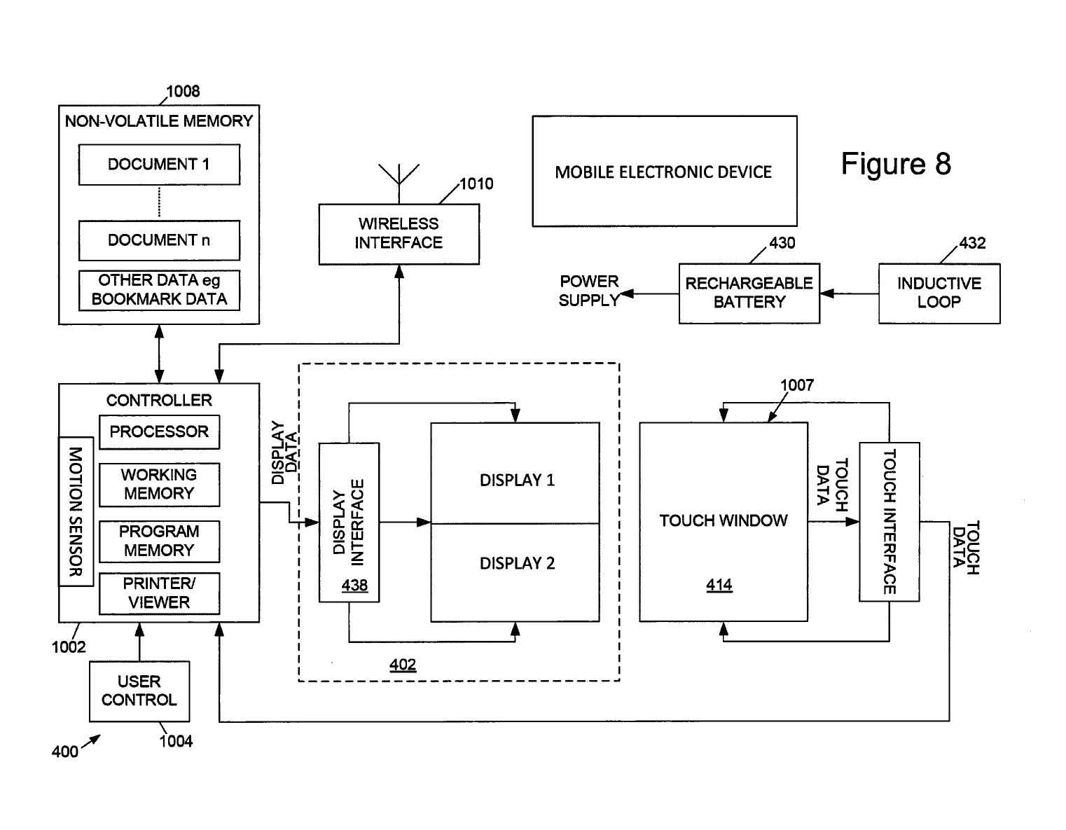

FIG. 8 shows a block diagram of example electronics of the display 100. The display comprises display panels (display 1; display 2) and a controller 1002 which includes a processor, for example an ARM™ device, working memory and program memory coupled to one or more display interface integrated circuits 438 for driving the pixel arrays of the panels. One or more touch interface integrated circuits 1006 may optionally be provided to interface with the touch electrodes on front window 414 to provide touch data to controller 1002. The controller may also include a motion sensor which is capable of detecting when the display is rotated, as described above.

The display may comprise a rechargeable battery 430 and/or inductive loop 432, and/or may be powered via a USB connection. An inductive loop 432 may be used to charge a rechargeable battery 430 which has associated circuitry for providing a regulated power supply to the system.

The program memory in embodiments stores processor control code to implement functions including an operating system, various types of wireless and wired interface, document retrieval, storage, annotation (via the touch interface) and export from the display. The stored code also includes code 1003 to implement a document viewer/printerless printing function, for example interfacing with corresponding driver code on a ‘host’ device.

The controller 1002 interfaces with non-volatile memory 1008, for example Flash memory, for storing one or more documents for display and, optionally, other data such as user bookmark locations and the like. Optionally a mechanical user control 1004 may also be provided.

A wireless interface 1010, for example a Bluetooth™ or WiFi interface may be provided for interfacing with, e.g., a mobile electronic device. For example, the wireless interface can be used by the display to receive image data from a mobile electronic device and transmit touch data back to the mobile device. The wireless interface 1010 may comprise a Bluetooth™ RF chip and antenna.

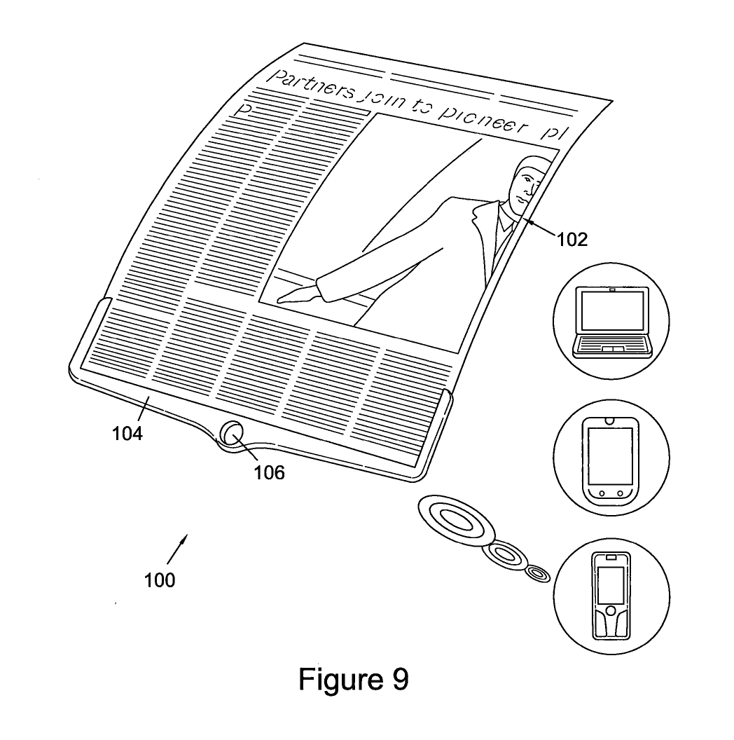

Regarding the above-mentioned advantageous feature of a single edge drive (SED) display, an SED device is described in the applicant's unpublished pending application GB1209033.8 (“Electronic Reading Devices”) filed on May 22, 2012. Each display panel of an embodiment may comprise a SED display unit or device as described with reference to FIGS. 9-22 below. For all SED-based arrangements and methods described below, each device may be used as a display panel and each handle as an edge region of the display panel, the edge region configured to couple to the coupling means at the spine of a foldable electronic display embodiment.

SED Display Unit Arrangements and Related Methods

An arrangement provides a flexible electronic reading device, the device comprising a display part and a handle, wherein said display part comprises: a display backplane on a flexible substrate; and a display mounted over said display backplane; wherein said handle is located at one edge of said display backplane and contains display interface electronics for said display; and wherein said display part of said electronic reading device comprises a unitary, continuous structure lacking a separate housing.

Broadly speaking in embodiments the combination of the display and backplane are integrally formed in the sense that that they constitute a continuous, one-piece structure from which the various components cannot be non-destructively separated. There is no separate housing for the display and backbone (although there is a handle along one edge).

In embodiments of the device, the combination of the display and backplane themselves provide sufficient stiffness for the device to be self-supporting when held by the handle and essentially the entire device is fabricated on the flexible, plastic substrate of the display backplane. This is, in embodiments, extended beyond the border of the display on at least three sides and used to mount the display interface electronics, using chip-on-plastic technology, and to run the tracks to the display drive electrodes around the edges of the display. Thus in embodiments there is no internal or external stiffening frame for the device and no rigid front panel (although there may be a thin, for example less 100 μm, protective front layer over the display).

In embodiments the display interface electronics includes a plurality of pixel driver chips, which are mounted in the handle, preferably on an extension of the plastic substrate. In embodiments these include at least one gate driver chip and at least two source/drain driver chips, one of the source/drain driver chips driving a set of data lines extending from each edge of the display (in a direction generally parallel to the handle). In embodiments of the device which include a touch sensitive screen, for example a projected capacitance touch sensitive screen, a similar technique may be employed to connect to either end of the line of a touch sensing track. This is because the indium tin oxide (ITO) tracks are relatively resistive and thus by connecting to either end of the track line, with an electrical break in the middle of the track, and providing a separate touch sensing chip for each end of the track, finer lines and hence more accurate touch sensing may be implemented on larger area displays.

In preferred embodiments the lateral extension of the plastic substrate beyond the display edge is concealed by a border of the electronic reading device, which may comprise an opaque region around the border of the display behind the transparent front protective layer (except where a handle is located).

In other embodiments the tracks to the display drive electrodes around the edges of the display may be run behind the display area and the display may be substantially borderless.

In some embodiments a rechargeable battery for the display is located within the handle, which because the remainder of the display is light, facilitates one-handed user operation. More particularly in such embodiments the centre of mass of the device may then be located within a lower part of the device, at a distance of no greater than 50%, 33%, 20%, 15% or 10% from the lower end of the device. Optionally the centre of mass of the device may be located substantially adjacent a user control in the handle. Such an arrangement further facilitates one-handed user operation.

In other embodiments the battery may comprise a thin-film flexible battery such as a polymer battery, and this may extend over a majority, optionally substantially all the rear surface of the device. In this way a relatively large capacity battery may be ‘concealed’ as part of the device. In embodiments the device includes a flexible printed circuit board (PCB) behind the display backplane. Then components on the PCB may be laterally arranged over a first region behind the backplane surface and the flexible battery may be located in a second, non-overlapping region. In some preferred embodiments the device includes an inductive loop to receive power for charging the rechargeable battery; this may extend around the border of the device, for example concealed by the opaque border region.

In embodiments the display may be monochrome or colour. The display may be an electrophoretic display or an electrofluidic display; in some preferred implementations the display is a colour electrofluidic display. In some preferred embodiments the display includes a touch-screen layer on a front surface, for example to operate with a stylus or a finger; this may be projected capacitance touch sensing layer or an inductive stylus sensing layer. In embodiments the touch sensing/screen layer is laminated to the front of the display; optionally, but not necessarily, a thin transparent protective film may be provided over the front surface, for example having a thickness less than 0.5 mm, 0.3 mm, 0.2 mm or 0.1 mm. In some preferred embodiments the touch-screen is combined with the protective film in a single layer.

Although embodiments of the device include a handle along one edge, this is not essential, and a self-supporting device may be fabricated as a unitary structure.

Thus a related arrangement provides a flexible electronic reading device, the device comprising: a display backplane on a flexible substrate; a display mounted over said display backplane; and display interface electronics for said display, coupled to said display backplane; wherein said display backplane comprises active matrix pixel driver circuitry on a plastic substrate; wherein said plastic substrate extends beyond a border of said display; and wherein at least a portion of said display interface electronics is fabricated on said plastic substrate.

In embodiments the plastic substrate extends beyond the border (active area) of said display on one or more sides, and one or more pixel driver chips are mounted on these extended sides of the plastic substrate using chip-on-plastic technology (although other embodiments lack such a border). In embodiments the plastic substrate extends beyond the border of the display on four sides. In addition a flexible printed circuit board (PCB) is joined by adhesive to the backplane and the backplane is connected to the PCB by vias which run through to a display side of the backplane. The vias connect to anisotropic conductive film located in the adhesive layer.

These approaches facilitate a unitary, continuous structure for the device, which then does not require any separate housing. This in turn substantially reduces the thickness of the device. In embodiments a rear surface of the device is substantially completely flat up to one, three, or all four edges of the device.

Some embodiments of the electronic reading device provide a hinged display, for example comprising at least one hinge running in parallel to the handle to enable one portion of the display to be folded behind another. For example the unfolded display may have substantially an A4 or similar size, with the handle at the bottom. Then the top half of the display may be folded behind the lower half of the display to provide an approximately A5 size display; Optionally this may then be held in portrait mode with the handle at the left or the right. Optionally the orientation of the device may be detected automatically, for example by means of an accelerometer or the like.

In other embodiments the one or more hinges may run perpendicular to a handle along a bottom edge of the display and one or more flaps of the display may fold along a vertical line. In this case the handle may also be foldable (or may be shorter than the full width of the display, so that it does not run across a hinge “break”).

In some embodiments the display may be Z-foldable, that is having one mountain fold and one valley fold so that, when folded, one part of the display is located between two adjacent regions of the display. This may be implemented, for example, by providing three display screen hingedly connected to one another.

Where the display incorporates a hinge, this can conveniently be combined with embodiments in which electrode lines running perpendicular to the hinge direction are broken across a line of the hinge and driven from opposite edges of the display, as previously described. Either the gate or the drain/source lines may be broken but since the drain/source lines carry greater current in embodiments these are driven from either edge of the display, for example by separate driver chips. Thus, for example, where the handle runs along the bottom of the display and the hinge is parallel to the handle one set of drain/source lines may run upwards between the handle and the hinge and a second set of drain/source lines may run downwards from an upper edge of the display towards the hinge, the extended border of the flexible substrate being employed to run tracks around the edge of the display to drive the upper set of drain/source lines from the top. Although the display hinge will hinge the flexible border of the substrate carrying the tracks as well as the display itself, it is relatively straightforward to provide a set of jumpers, for example on a flexible PCB, to maintain an electrical connection when the display unit Is in its hinged state. Alternatively these tracks at the border of the display may simply be broken when the display is in its hinged configuration since, at that point, the hinged away portion of the display is not needed. In this latter case a set of contacts may be provided such that when adjacent portions of the flexible substrate are hinged flat to define the full sized display. Contacts on the track of one portion of the display may abut against corresponding contacts on the second portion to make the electrical connection. The skilled person will appreciate that alternative approaches may also be employed. It will further be appreciated that although, for convenience, a description has been given of a display in which the upper portion folds behind the lower portion, equally a left portion could fold behind a right portion of the display or vice-versa, or there may be multiple hinges provided, for example to allow the display area to be reduced by one third, two thirds, three-quarters and so forth. Similarly where one set of mutually perpendicular electrode lines for driving a display is broken at the hinge, it is not necessary to orientate the hinge so that the drain/source lines are broken and, for example, gate lines may be broken. Alternatively jumper connections may be provided as previously described so that no connections are broken at the point of hinging.

In preferred implementations the display interface electronics also includes electronics for a wireless link to a second electronic device. Such a device may be, for example, a laptop or desktop computer, a PDA (personal digital assistant), a mobile phone, in particular a Smartphone, or other such devices. The wireless interface may be a radio frequency interface, for example a WiFi or Bluetooth™ interface or an optical, for example infra-red, interface. This enables documents and the like to be transferred to the electronic reader for display and optionally back from the electronic reader, for example where allocated by the user. (Here ‘document’ is used broadly to include not just words on a page but also, for example, images, video, web pages, music and so forth).

In some preferred implementations the wireless link electronics includes a processor coupled to memory and stored processor control code. The control code is configured to receive and process print data from an output of a printer driver of the second electronic device. Then to display a documents the device may merely be provided with what appears to an application on the second electronic device to be a conventional printer driver but which is in fact a communications link to the electronic reading device. The electronic reading device receives this print data which it stores and processes for display, in embodiments as if the display were a printed page. This provides a convenient method of interfacing to the device, although other hardware/software interfaces may in general also be provided—for example to accept various types of document and image data such as PDF (portable document format) data, markup language data and the like.

A related development provides a method of manufacturing a flexible electronic reading device, the method comprising: providing an active matrix display backplane on a plastic substrate; mounting a display on said display backplane; providing a handle at one edge of said display backplane, wherein said handle contains display interface electronics for said display; the method further comprising: configuring said combination of display and display backplane to be self-supporting when held by said handle without providing a separate casing for said display and display backplane.

A method of manufacturing a flexible electronic reading device comprises: providing an active matrix display backplane on a plastic substrate; mounting a display on said display backplane; attaching a flexible PCB behind said matrix display backplane; locating a flexible battery on a region of said flexible PCB; providing an inductive charging loop for said battery; providing a front window for said display; providing a rear cover for said device; encapsulating the assembly to provide a self-supporting, integrally formed, unitary flexible electronic reading device.

Referring to FIG. 9, this shows a first embodiment of an electronic reading device 100 comprising a display part 102 and a handle 104 located at one edge of the display. New display part 102 is flexible and self-supporting when held by the handle, but the device lacks an internal stiffening frame and instead relies upon the structure of the device itself to provide sufficient support. This is facilitated by the device being very thin, in embodiments less than 3 mm thick, and very light, in embodiments less than 200 grams (facilitated by the device being constructed mainly of plastic, including at least some of the functional electronic components of the device). In embodiments the device is sealed and waterproof and has no physical external connections (power and communications are both exclusively wireless).

In embodiments the device has no separate housing or enclosure; instead the device or at least substantially the entirety of the display part of the device has a continuous, unitary structure which is integrally formed. Thus in embodiments substantially all internal voids are filled with a gel-based encapsulation material, and the device is sealed around the edge in a similar manner. Furthermore embodiments of the device lack a bezel around the edge of the device, or at least around the edge of the display part of the device, facilitating flexibility and also foldability because the display portions in foldable embodiments may then be stacked neatly behind one another. A flexible, and in embodiments foldable device is further facilitated by the use of very thin battery technology, as described later.

The screen is preferably touch sensitive although a single user control 106 may also be provided. This may, for example, comprise a refresh button that automatically refreshes data stored within the device via a wireless internet connection, for example one or more RSS (Really Simple Syndication) feeds via the internet.

As described further later, embodiments of the device may be configured to function as a ‘viewer’ for other electronic devices including, but not limited to: a laptop or desktop computer, a PDA (personal digital assistant), a mobile phone or smartphone, or the like. Thus in embodiments the electronic reading devices provided with wireless interfaces such as an infra-red or Bluetooth™ interface and/or a WiFi or similar interface. Embodiments of the device are configured to enable it to be used as a second screen or the primary screen of the ‘host’ electronic device.

In embodiments the display gives the appearance of paper. Optionally the device may be configured so that it appears to the host device as a conventional, paper-based printer—for example enabling a document to be displayed on the device by opening the document and clicking print. This can be achieved by providing an appropriate printer driver for the host device (for example as described in our WO2009/053738) and providing corresponding software on the document reading device. In embodiments the display may be borderless, to enhance the impression of ‘electronic paper’. Alternatively the display may have the appearance of being borderless by cropping the margins of an image to be displayed and then arranging for the border of the electronic reading device to give the appearance of the margins so that, when displayed, the document page appears, to a viewer, to extend substantially to the edges of the device. Thus in embodiments the borders of the device are coloured to match a white paper background. Where borders are present they may be for example of width around 1cm and extend to all the edges of the device (optionally excluding the handle part) and internal colouring is employed at a corresponding depth within the device to the active display media to reduce any visual discontinuity at the boundary of the active display region.

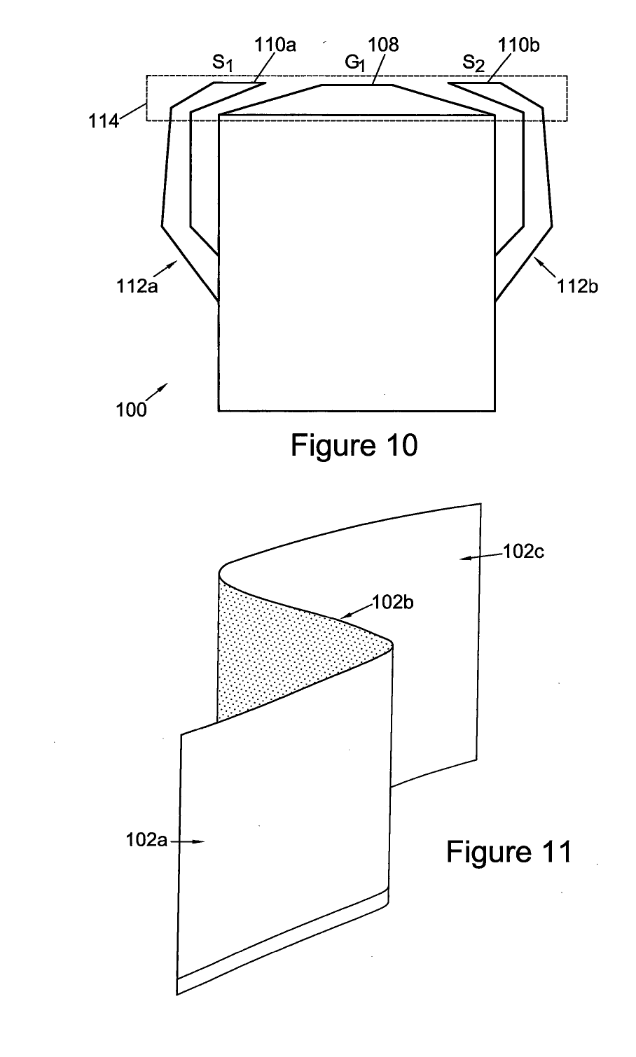

FIG. 10 shows an internal arrangement of the display interface electronics for the device at FIG. 9. In the device at FIG. 9 the control electronics for the device are concealed within handle 104. This includes display driver integrated circuits for the display, which may be an electrophoretic display or electrofluidic display. As illustrated in FIG. 10 the display interface electronics comprises a gate driver integrated circuit 108 and first and second source driver integrated circuits 110a, b. In embodiments the source lines of the display are driven from opposite edges of the display and the gate lines are driven from the handle edge of the display, and thus connections 112a, b between the source driver lines of the display backplane and the source driver integrated circuits 110a, b run along edges of the display portion 102, concealed under a thin border as previously described. The remainder of the device electronics, comprising communications, a micro controller, memory and so forth, may be mounted on a strip of printed circuit board within handle 104. There are no physical sockets for the device, and therefore handle 104 may be very thin. A battery for the device may either be distributed over part or all of the region of display part 102 or located within handle 104. Optionally handle 104 is foldable, which may be achieved by dividing the components between two parts within the handle connected by a flexible connector, for example a portion of flexible printed circuit board. In embodiments the user experience is that holding the device feels like merely holding just the display.

Referring next to FIG. 11, this shows a foldable embodiment of the device 100 of FIG. 9 in which, in this example, the display stack comprises three portions 102a, b, c which may be folded so that display portions 102b, c are behind portion 102a this facilitates changing between, for example, an A4/US letter format and a column format, for example having a width:height aspect ratio of greater than one:two—which is convenient for one-hand reading of documents and other material. In embodiments the vertical hinges may be provided by interlocking formations on abutting edges along either side of the hinge, optionally pulled together by an elastic material lying across the hinge. Electrode lines across the hinge may be broken or, where these are continuous across the hinge, a flexible coupling such as flexible PCB may be employed.

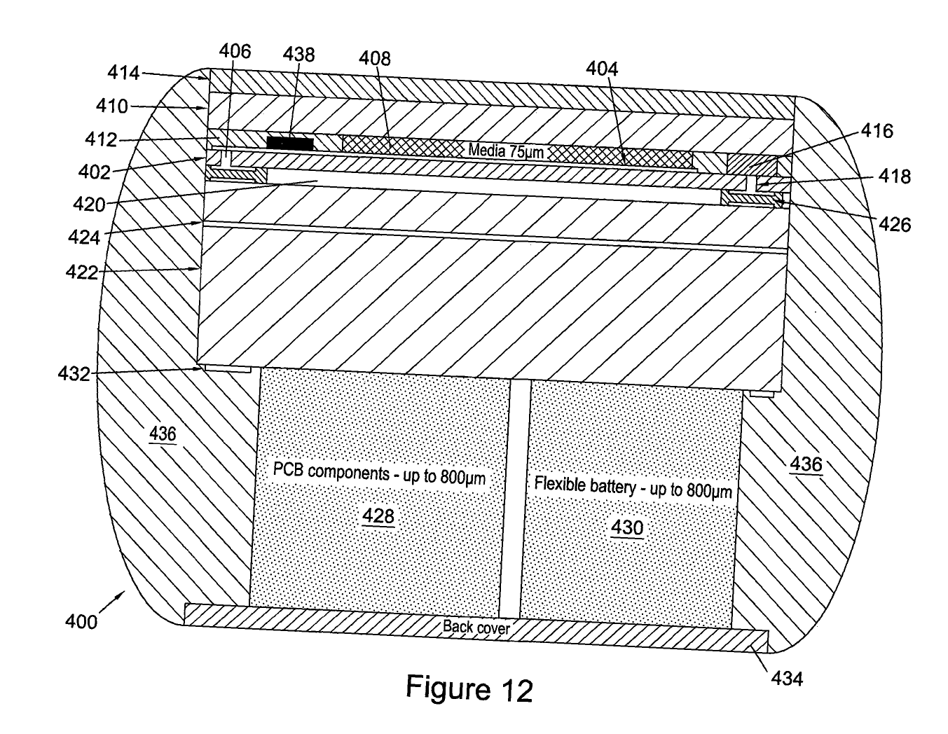

Referring now to FIG. 12, this shows a vertical cross-section view through a second embodiment of an electronic reading device 400 in which electronic components of the device are distributed over a surface of the device on a flexible PCB. Nonetheless a display stack of the type illustrated in FIG. 12 may also be employed for the embodiment of FIG. 9.

In more detail, the structure comprises a substrate 402, typically a plastic such as PET (polyethyleneterephthalate) or pen(polyethelenemaphthalene) on which is fabricated a thin layer of organic active matrix pixel circuitry. The circuitry may comprise an array of organic (or inorganic) thin film transistors for example as previously described in our WO01/47045, WO2004/070466, WO01/47043, WO2006/059162, WO2006/056808, WO2006/061658, WO2006/106365 and WO2007/029028. Broadly speaking in embodiments the backplane is fabricated using solution based techniques patterned by, for example, direct-right printing, laser ablation or photolithography to fabricate the thin film transistors. In embodiments the active devices have a thickness of order 5-10 μm. In embodiments this layer has a thickness of order 50 μm and has integrated encapsulation. This substrate/backplane layer bears row and column, dataline and address conductive tracks 404, connected to the rear of substrate 402 by vias 406. We here refer to front as being towards the display surface of the device and rear as being towards the rear of the device.

A display medium 408 is attached to substrate 402, for example by adhesive. In preferred embodiments the display medium is a reflective display medium (which facilitates daylight reading), for example an electrophoretic display medium or an electrofluidic display medium. Where an electrophoretic display medium is employed a colour display may be provided by providing a colour filter array 410 over the display medium; optionally this may also perform an encapsulation function. Additionally or alternatively a moisture barrier may be provided over the display, for example comprising polyethylene and/or Aclar™ (a fluropolymer, polychlorotrifluoroethylene-PCTFE). In some embodiments the thickness of the display medium is of order 75 μm and that of the encapsulation/colour filter array of order 120 μm.

Where an electrofluidic display is employed, for example of the type available from Gamma Dynamics, Inc. Ohio USA, the colour filter array may be omitted. The use of an electrofluidic display facilitates improved brightness/contrast as well as near video display update rates and high resolution, in embodiments of order 225 pixels per inch.

In embodiments whichever display medium is employed, an edge seal 412 is provided to seal the edge of display medium 408 to the edge of the display module.

A front window 414 is provided over the display, for example comprising a thin layer of PMMA (polymethylmethacrylate), in embodiments with a thickness of order 75 μm. Where the device is touch sensitive, this layer may also include conductive row and column lines for the touch circuitry, in embodiments employing fine line metal (FLM).

The touch sensing circuitry may be operable by finger and/or a stylus. A connection to the touch sensing layer may be made by a Z-axis conductive pad 416 which connects to the touch electrodes in window 414 through CFA/encapsulation layer 410 (for example by vias, not shown) and vias 418 through substrate 402 bring the touch array connections to contact pads on the rear of substrate 402.

An adhesive layer 420 connects the substrate 402 to a flexible PCB 422 (which may incorporate circuitry 424 for an inductive stylus sensor. Connections between the contact pads on the rear of substrate 402 and the flexible PCB employ an anisotropic conductive film (ACF) 426. The illustrated structure facilitates the omission of a separate moisture barrier under substrate 402, although such a barrier may be incorporated if desired.

Flexible PCB 422 carries electronic components 428, for example surface mounted components, and a thin film flexible polymer battery 430. In embodiments the PCB 422 has a thickness of order 600 μm, and the components/battery have a thickness up to 800 μm. Flexible PCB 422 also bears a conductive loop 432 around the border of the device for inductive charging of battery 430.

The components and battery are provided with a thin rear cover 434 (optional). The display and PCB module is encapsulated, for example by a gel-based potting material or encapsulant 436 which, in embodiments, fills all the internal gaps, extending around the edge of the display module, over the flexible PCB, and attaching rear cover 434.

Like the embodiment of FIGS. 9-11, the display may be foldable in half or in thirds. In embodiments the device entirely lacks mechanical controls and, in embodiments, all connections to the device are wireless; embodiments of the device lack speakers.

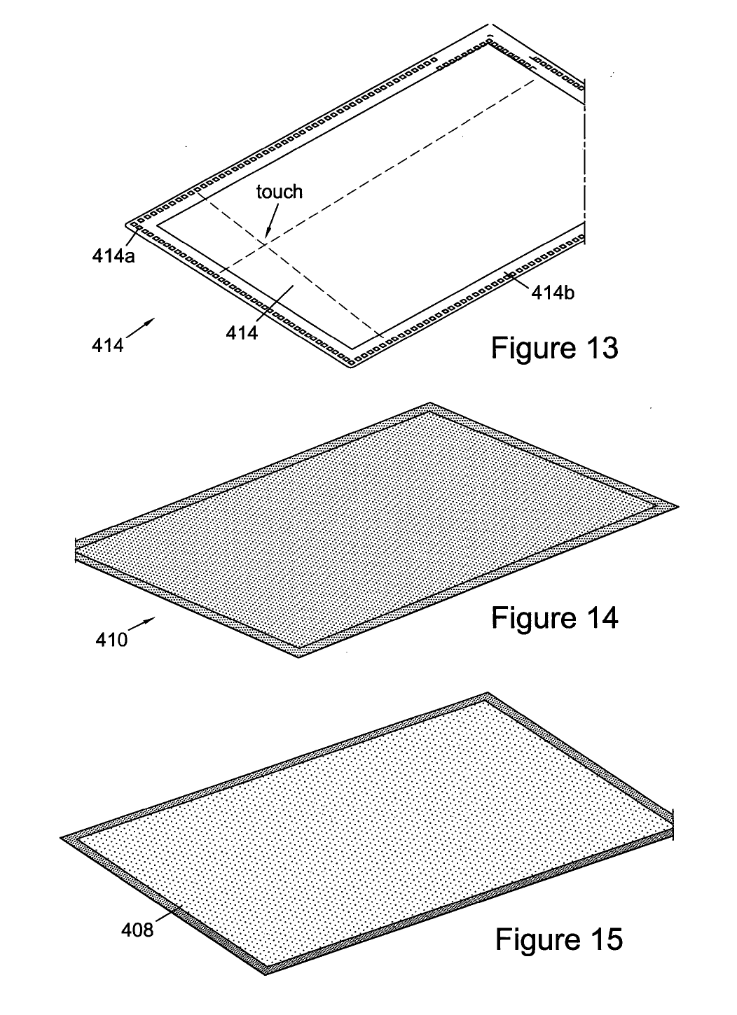

Referring next to FIGS. 13 to 21, these show perspective views of layers illustrated in the cross-section of FIG. 12. Thus FIG. 13 shows plastic front window 414 which protects the display medium and, where present, the colour filter array. This window has a plurality of pads 414a around the edge which connect to tracks on the touch sensor FLM (fine line metal) in the case of a capacitive sensor. In embodiments the fine line metal has a width in the range 2-5 μm. The window 414 provides a narrow border 414b around the active display area.

FIG. 14 shows a plan view of the colour filter array 410, again with a narrow border. In embodiments this may provide a regular pattern of red, green, blue and white colours.

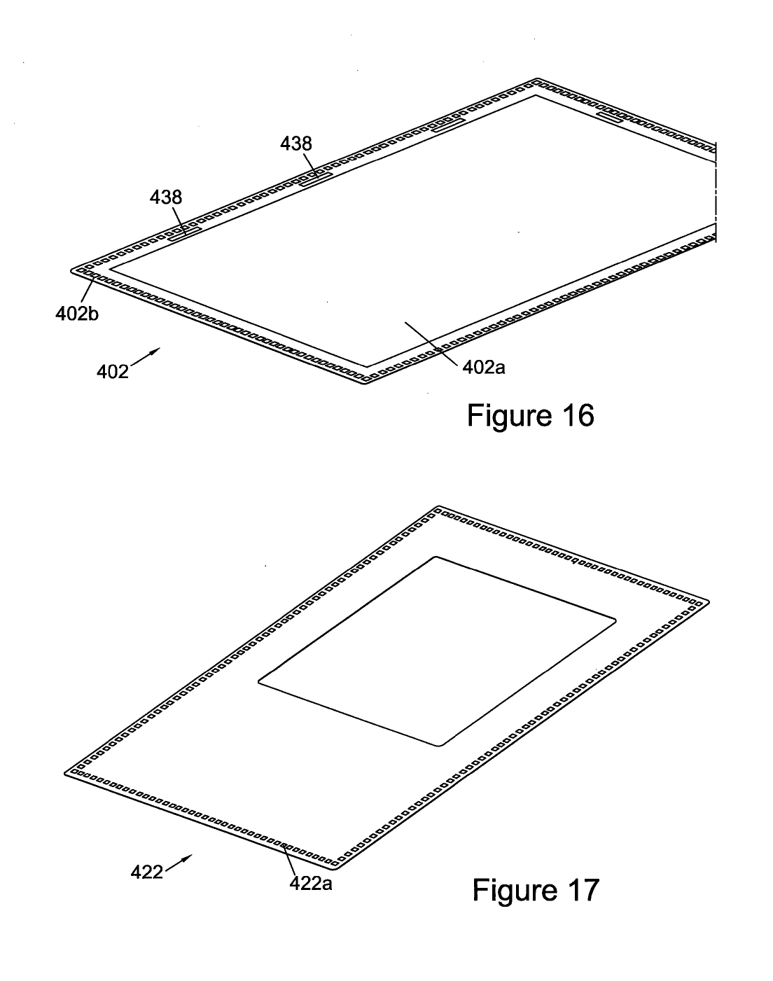

FIG. 15 shows the display medium 408, with the active area of the media substantially following the entire available area. FIG. 16 shows substrate 402 having an active backplane area 402a for driving pixels of the display medium 408. Substrate 402 is provided with pads 402b around the edge to carry touch signals between the touch electrodes of window 414 and touch sensing circuitry on PCB 422. Substrate 402 also bears a plurality of display driver integrated circuits 438, mounted on substrate 402 using chip-on-plastic technology. Connections to these when made, for example, by other pads (now shown).

FIG. 17 shows the front (display-facing) face of flexible PCB 422, illustrating pads 422a around the border which connect to the display/touch sensing module via an isotropic conductive film.

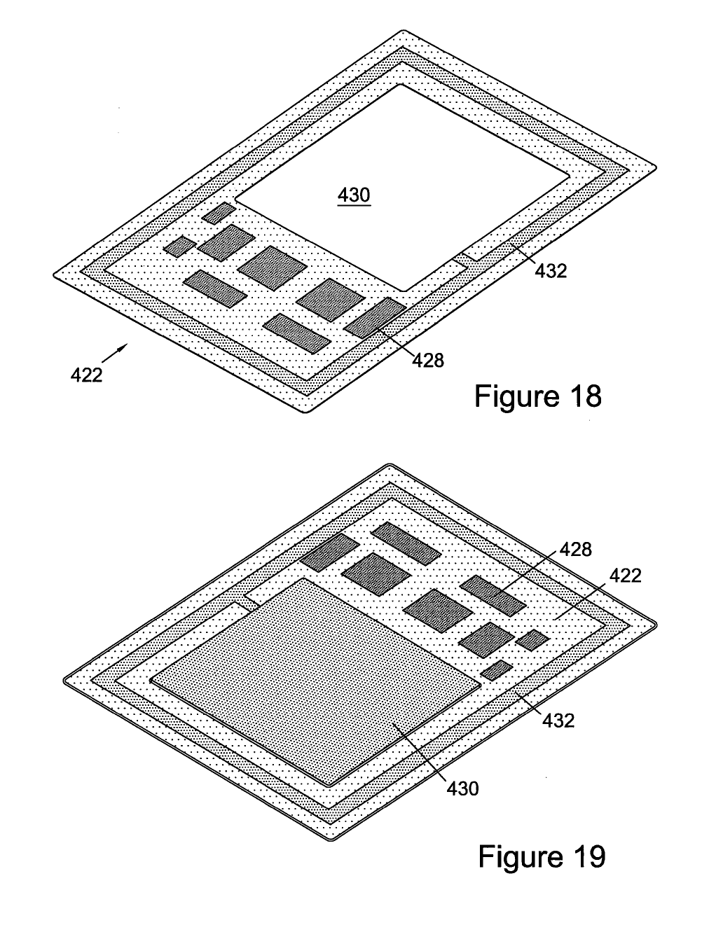

FIG. 18 shows, schematically, the rear face of PCB 422, illustrating the components 428, battery location 430 and inductive loop 432.

FIG. 19 is a similar illustration to FIG. 18 showing the flexible battery 430 in position. The electronic components 428 include, in embodiments a single chip processor, a display engine, and Bluetooth™/near-field communications. As illustrated the battery 430 may be recharged by holding the device over an inductive charging pad, but in alternative approaches a capacitive charge electrode may be employed for capacitive charging.

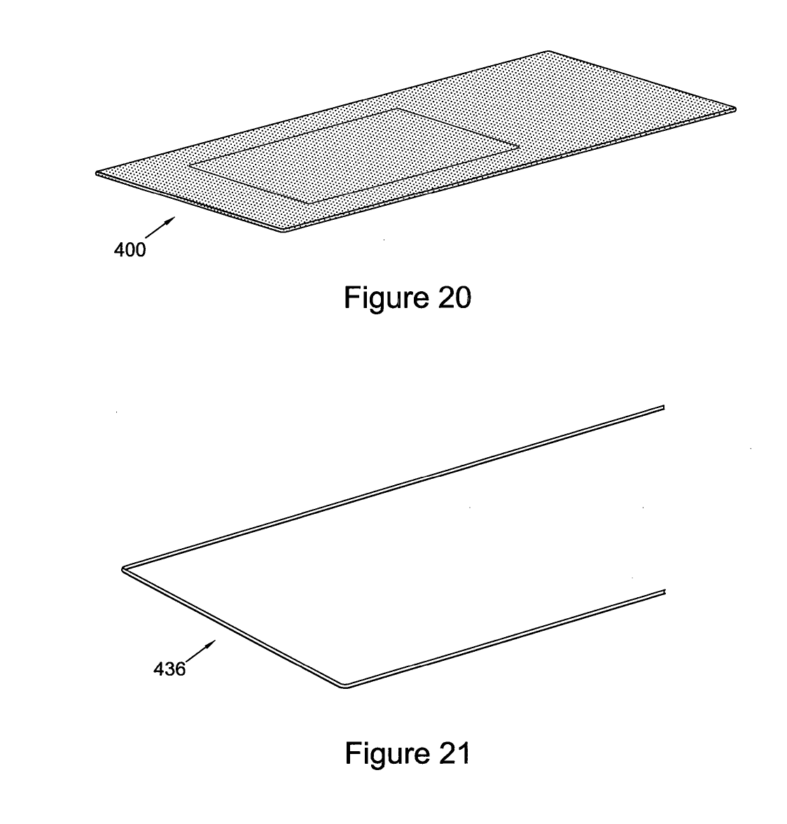

FIG. 20 shows a rear view of the device 400, illustrating the thinness of the device—in embodiments the device is of order 2 mm thick. FIG. 21 shows an edge profile of the device formed by encapsulant 436.

Any of the above arrangements or developments, e.g., methods, relating to a SED device may be implemented using electronics similarly as shown in FIG. 8, wherein the display 1 and 2 of FIG. 8 are replaced by a single SED display screen.

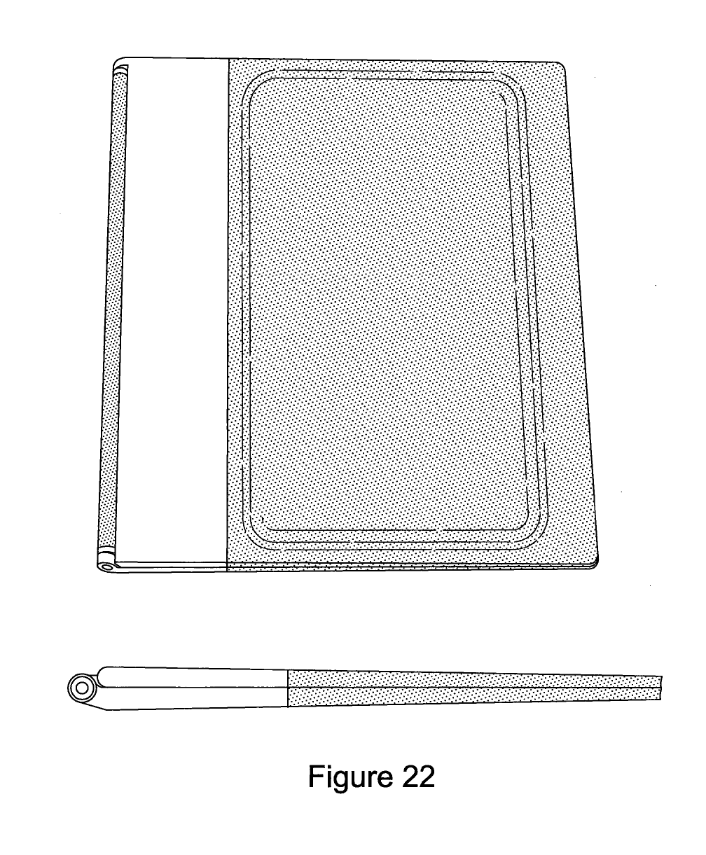

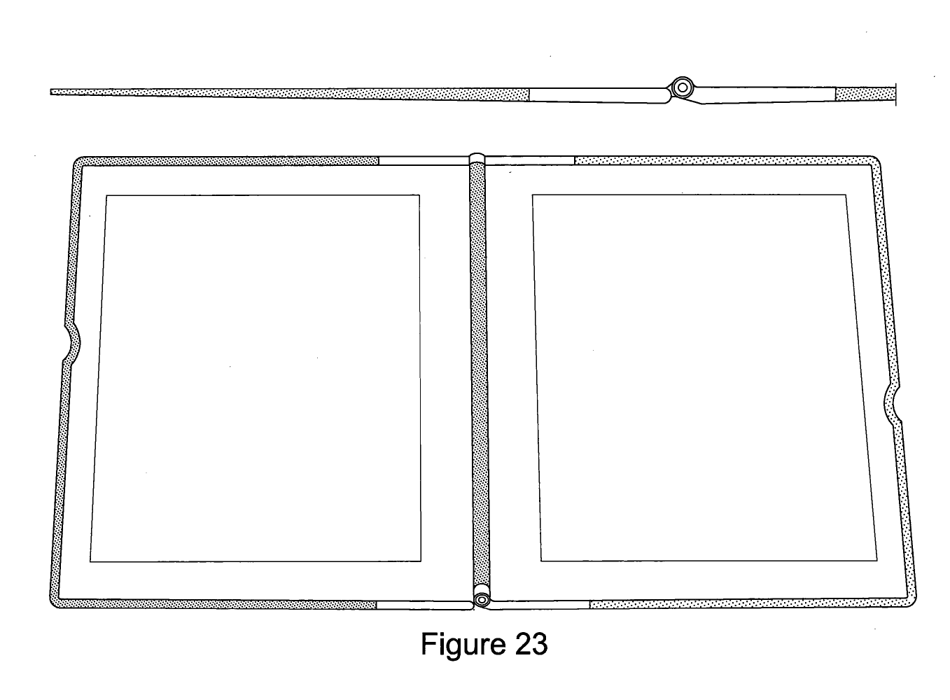

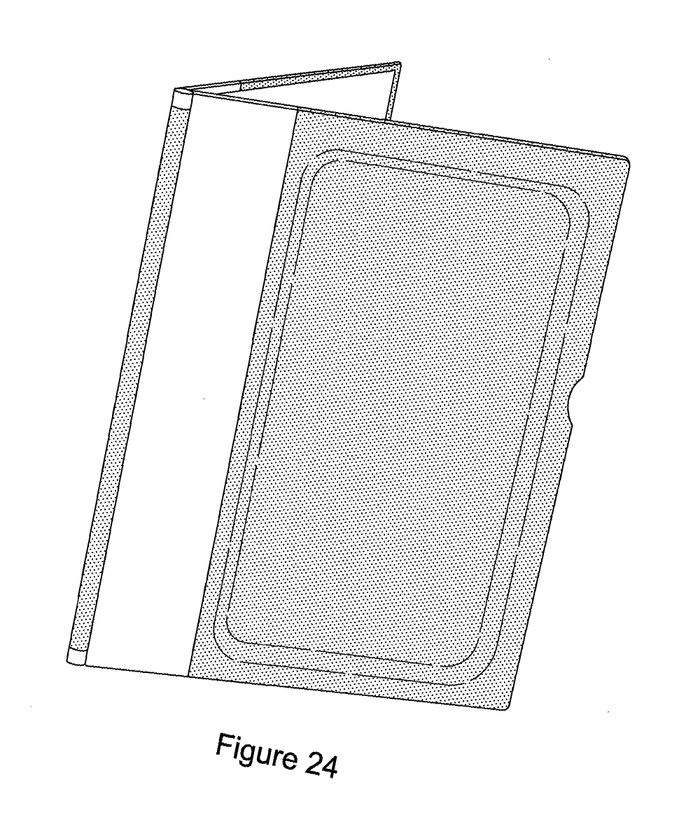

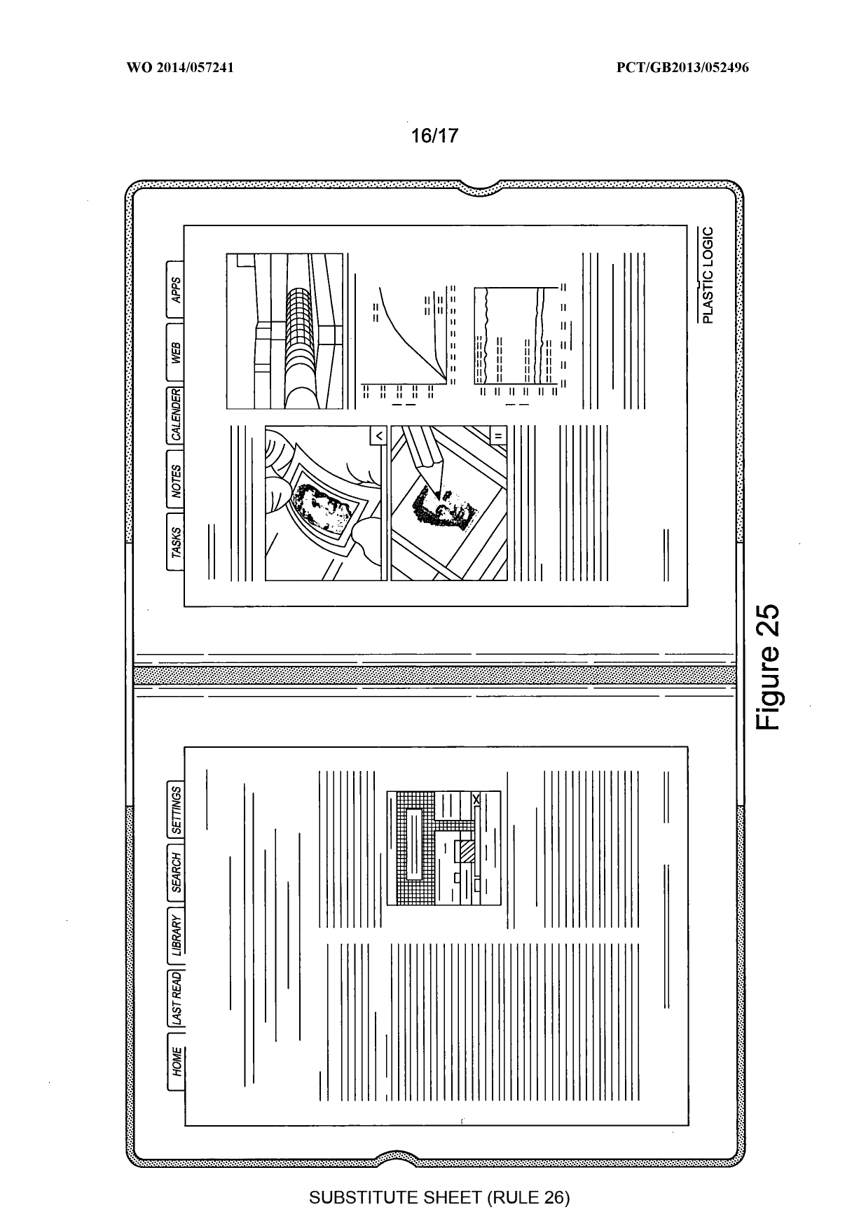

We now describe a further concept, which may allow the use of a “mid-frame” as an external part of the display panel. Such an arrangement advantageously allows a product to be much thinner than if there was a separate “mid-frame” and back cover. This may in an embodiment be achieved by effectively laminating the display screen unit directly to the outer casing of the display; this may be applied advantageously to thin display screens which require some support to stop “kinks”. While this concept generally relates to FIGS. 22-27 (an embodiment may have features as shown in any one or more of these figures), it may however be combined with any one or more of the above described aspects and optional features of embodiments in any combination.

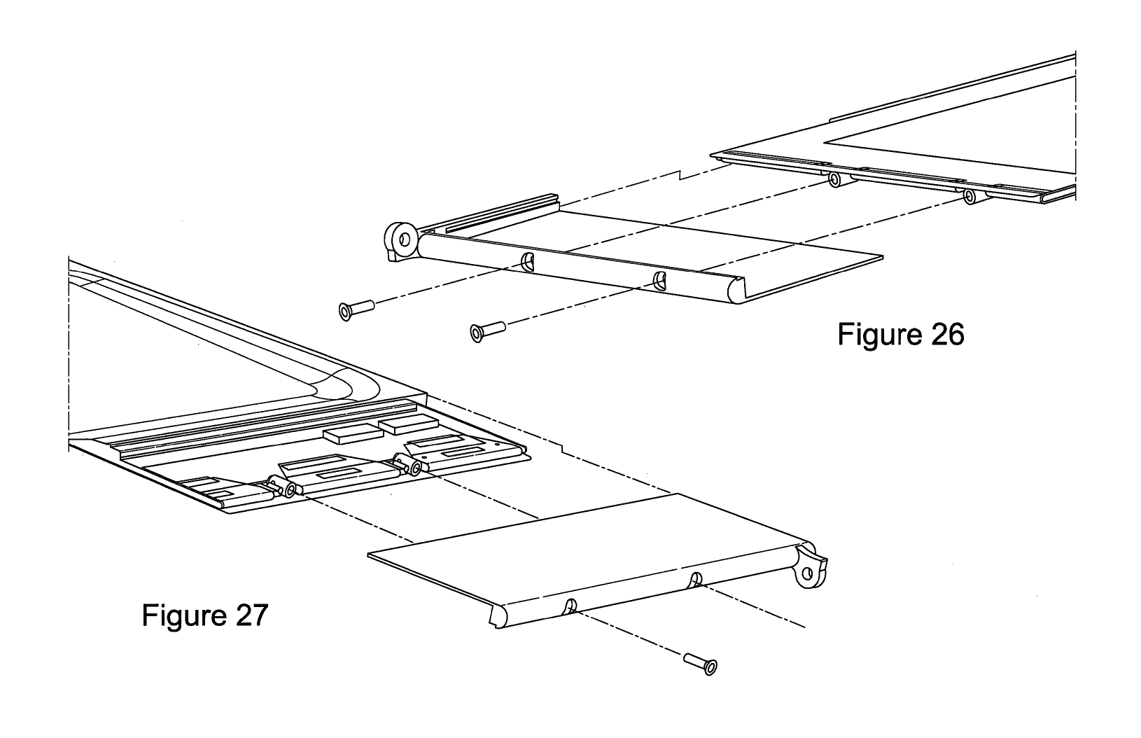

FIGS. 26 and 27 provide cross sectional exploded views showing how an embodiment of the concept may be assembled. The display is mounted on a the “cosmetic mid-frame” which slides onto the “structural component” which includes at least part of the hinge mechanism. The two parts are then fastened with screws such that they can no longer move apart and the screws also support the display panel and mid-frame to reduce or prevent deflecting of the display panel and mid-frame when pressed from above.

An embodiment of the concept may allow incorporation of a flexible display screen into a product so that it is difficult for a user to break the screen. One way of doing this is by mounting the display onto a mid-frame; however this is generally disadvantageous due to requiring an additional layer of material which make the product thicker/heavier and/or because if electronics, e.g., a PCB etc. is mounted on the back an additional cover may be needed to protect the electronics.

In essence, an embodiment of the concept may only have five parts (only 3 unique ones): the “mid-frame” (as represented by, e.g., the largest sections in FIG. 22, these sections further from the hinge mechanism), the metal enclosures (structural components comprising protective cover for electronics), and the rod in the middle (e.g., bar or barrel of a hinge).

An embodiment of the concept takes the “mid-frame concept” and makes the mid-frame part of the external housing, e.g., rather than being between electronics and screen. Thus the mid-frame may be both decorative and functional and/or remove the requirement for an additional “layer” or “cover”, e.g., casing or housing. Advantageously, an embodiment may thus be less than or equal to about 1 mm thick in places. An embodiment may be constructed to be as hard or soft as required, or to only flex in one direction for example.

The electronics, e.g., PCB, battery etc., are preferably substantially enclosed by structural components, which may be considered as forming metal boxes in the centre of the display. This structural components, e.g., metal, may thus serve one ore more purposes, e.g.,; to enclose (e.g., thus protect, e.g., from mechanical damage or from ingress of water, etc.) the electronics; to rigidly support the non-flexible components, e.g. electronics comprising PCB; to provide a strong and/or reliable way of repeatedly folding the display.

Since the thickness of the display according to this concept may be very low, an embodiment may be very light for it's size, e.g., less than or equal to around 400 g.

No doubt many other effective alternatives will occur to the skilled person. It will be understood that the invention is not limited to the described embodiments and encompasses modifications apparent to those skilled in the art lying within the spirit and scope of the claims appended hereto.

1. A foldable electronic display, comprising:
first and second display panels, each said display panel having opposing viewing and back sides and a curved edge between said viewing and back sides and having an array of pixels comprising display medium, each said display panel further comprising electronics to control said array of pixels to display an image on said viewing side; and
coupling means configured to retain a said edge of said first display panel adjacent to and substantially aligned to a said edge of said second display panel, wherein
said pixel array of at least said first display panel is curved to extend from said front, viewing side of the display panel at least to a region of said curved edge of the display panel, and
said coupling means is configured to allow rotation of a said display panel to roll the curved edge of a said first or second display panel over the adjacent edge of the other of the first and second display panels to open the display such that a boundary of the pixel array extension is not in an area visible to the user during said opening, said boundary in said region of said curved edge or back side of said first display panel.

2. Foldable electronic display of claim 1, wherein said adjacent curved edges are configured to allow a substantially constant distance between said edge of said first panel and said edge of said second display panel during said rotation, said distance preferably less than about 1 mm, more preferably less than about 0.5 mm and optionally zero.

3. Foldable electronic display of claim 1, wherein there is no intermediate element between the said edge of said first display panel and the said edge of said second display panel when the display is in a configuration wherein a user can view the viewing sides of the display panels.

4. Foldable electronic display of claim 1, wherein
at least one said display panel comprises a said pixel array having at least one margin portion comprising pixels that are not configured to be switchable by said electronics of said at least one display panel, and
a said margin portion comprises said edge of the pixel array.

5. Foldable electronic display of claim 4, wherein at least one fixed image is provided on a said margin portion and the display comprises electronics configured to control pixels of a said pixel array to display an option selected by a user, said option represented by a said fixed image.

6. Foldable electronic display of claim 1, wherein at least one of the display panels comprises:
a substantially rigid support for said electronics of said at least one display panel, said support in or on a portion of the at least one display panel, said portion substantially adjacent a said curved edge of said at least one display panel,
wherein an other portion of the at least one display panel is flexible.

7. Foldable electronic display of claim 1, wherein said coupling means comprises gears, said first display panel coupled to a first said gear and said second display panel coupled to a second said gear, the first and second gears configured to mesh to allow said rotation.

8. Foldable electronic display of claim 1, configured to display an image extending from the viewing side of the first panel to the viewing side of the second display panel.

9. Foldable electronic display of claim 1, wherein at least one said display panel comprises a single edge drive display.

10. Foldable electronic display of claim 1, wherein said display medium comprises an electrophoretic, electrowetting, or electrofluidic, liquid crystal or light emitting diode display medium.

11. Foldable electronic display of claim 1, comprising a protective spine cover extending over at least a portion of said rear side of said first display panel and at least a portion of said rear side of said second display panel and having slack to allow rotation of at least one said display panel relative to the other said display panel to close the display.

12. Foldable electronic display of claim 6, comprising a protective display panel cover having:
a flexible portion over a said other, flexible portion of the first display panel and a flexible portion over a said other, flexible portion of the second display panel; and
a substantially rigid portion over the or each said support.

13. Foldable electronic display of claim 12, wherein the protective display panel cover has a thickness that is tapered over at least one said display panel, said tapering from a said flexible portion to a said substantially rigid portion.

14. A foldable electronic display, comprising:
first and second display panels, each said display panel having opposing viewing and back sides and an edge between said viewing and back sides and having a screen comprising an array of pixels comprising display medium, each said display panel further comprising electronics to control said array of pixels to display an image on said viewing side, wherein each said display panel comprises a flexible support on the back side of the display panel to support the screen; and
first and second structural components, each said structural component comprising a protective cover and attached to a said display panel such that the protective cover covers said electronics of the display panel and a width of the protective cover extends from or over a said substantially aligned edge of the display panel to said flexible support of the display panel, wherein the protective cover has a surface region facing away from the electronics and arranged to be adjacent and in substantially the same plane as a surface region of the flexible support, said surface region of the flexible support on the back side of the display panel; and
coupling means to couple said first and second structural components such that a said edge of said first display panel is retained adjacent to and substantially aligned to a said edge of said second display panel while allowing at least one said display panel to rotate to open the folding electronic display for user viewing of the viewing sides.

15. (canceled)

16. Electronic book or e-reader comprising a foldable electronic display according to claim 1.

17. A method of unfolding an electronic display comprising a plurality of display panels, at least one said display panel having an array of pixels on a viewing side of the panel and extending at least to cover a region of a curved edge of the panel, the method comprising:
rolling the edge of said at least one display panel over an edge of an adjacent said display panel to open the display to a configuration wherein a user can view the viewing sides of the display panels,
wherein pixels covering said region of said curved edge are substantially not visible to said user viewing said viewing side when the display is in said configuration.

18. Method of claim 17, wherein pixels on said region of said curved edge of said at least one display panel are not configured to be switchable.

19. Method of claim 17, wherein said edges are in contact during said rolling.

20. Electronic book or e-reader comprising a foldable electronic display according to claim 14.
